(19) United States
(12) Patent Application Publication
(10) Pub. No.: US 2009/0092140 A1
(43) Pub. Date: Apr. 9, 2009

(54) METHOD AND APPARATUS FOR PROVIDING A HIERARCHICAL STRUCTURE FOR ROUTING

(76) Inventors: John F. Gibbons, Ballston Lake, NY (US); Neal A. Shackleton, Tierra Verde, FL (US); Michael Satterlee, Clifton Park, NY (US)

Correspondence Address: AT&T CORP., ROOM 2A207, ONE AT&T WAY, BEDMINSTER, NJ, 07921, US

(21) Appl. No.: 11/869,401

(22) Filed: Oct. 9, 2007

(51) Int. Cl. H04L 12/56

(52) U.S. Cl. 370/395.31; 370/392; 370/400; 370/408

(57) ABSTRACT

A method and apparatus for providing a hierarchical structure for routing over packet networks are disclosed. The method first receives one or more packets from at least one customer endpoint device with a Customer Edge (CE) functionality, wherein said one or more packets are destined for a destination node. The method locates a route for routing said one or more packets by consulting an interface specific routing table. The method then forwards said one or more packets towards said destination node using said route.

The present invention relates generally to communication networks and, more particularly, to a method and apparatus for providing a hierarchical structure for routing over packet networks, e.g., Internet Protocol (IP) networks and Virtual Private Networks (VPNs).

### BACKGROUND OF THE INVENTION

An enterprise customer may build a Virtual Private Network (VPN) by connecting multiple sites or users over a network from a network service provider. The enterprise customer's devices such as Customer Edge (CE) routers may be connected to the provider's network through Provider Edge (PE) routers. If an enterprise customer site, e.g., a VPN site, has multiple interfaces, e.g., CEs, accessing the network through the same PE router, then the multiple interfaces will share a Virtual Route Forwarding (VRF) table. However, if a customer needs a different VRF table to be used for a different set of interfaces, then the service provider has to instantiate the entire VRF for those interfaces. That means all the routes have to be duplicated for each unique forwarding instance. Duplication of all routes for each forwarding instance is very costly. Furthermore, the approach is not easily scalable to large VPN networks with several sites, and varying needs at each site.

### SUMMARY OF THE INVENTION

In one embodiment, the present invention discloses a method and apparatus for providing a hierarchical structure for routing over packet networks, e.g., Internet Protocol (IP) networks. The method first receives one or more packets from at least one customer endpoint device with a Customer Edge (CE) functionality, wherein said one or more packets are destined for a destination node. The method locates a route for routing said one or more packets by consulting an interface specific routing table. The method then forwards said one or more packets towards said destination node using said route.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary virtual private network with the current invention for providing a hierarchical structure for routing;

FIG. 3 illustrates a flowchart of a method for providing a hierarchical structure for routing; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing a hierarchical structure for routing over packet networks, e.g., Virtual Private Networks (VPN). Although the present invention is discussed below in the context VPN networks, the present invention is not so limited. Namely, the present invention can be applied for other packet networks e.g., Internet Protocol (IP) networks.

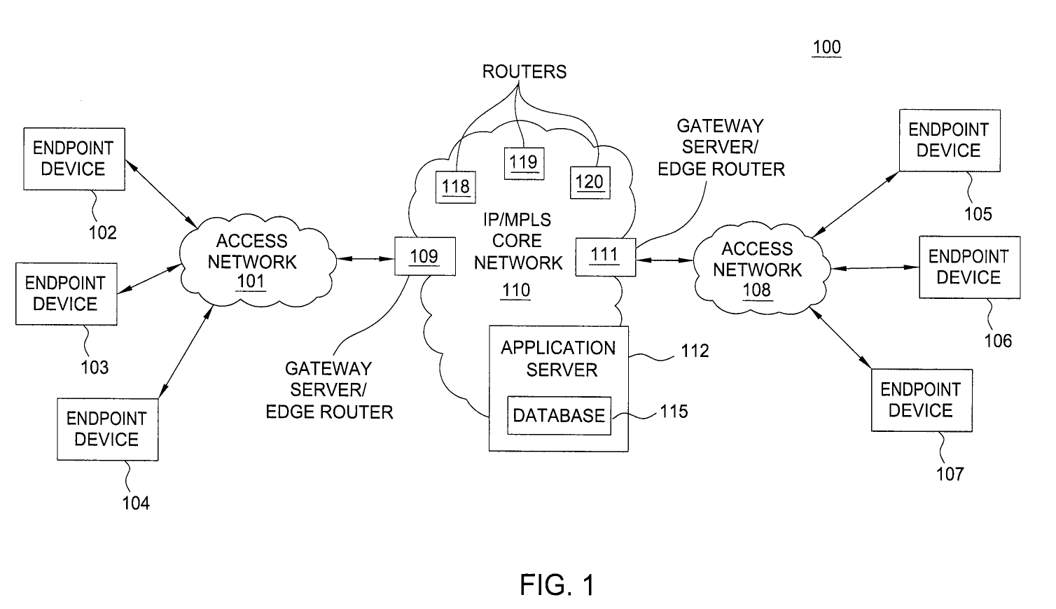

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or IPv6 and the like, to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, and so on are depicted in FIG. 1, the communication system 100 may be expanded by including additional endpoint devices, access networks, border elements, etc. without altering the present invention.

The above IP network is described to provide an illustrative environment in which packets for voice and data services are transmitted on networks. An enterprise customer may build a Virtual Private Network (VPN) by connecting multiple sites or users over a network from a network service provider. The enterprise customer's devices such as Customer Edge (CE) routers at the various locations may be connected to the provider's network through Provider Edge (PE) routers. If an enterprise customer site, e.g., a VPN site, has multiple interfaces, e.g., CEs, accessing the network through the same PE router, then the multiple interfaces may share a Virtual Route Forwarding (VRF) table. For example, there may be several user endpoint devices at each VPN site that are connected to the network. All users endpoint devices for the same VPN accessing the network via the same PE router, share the same VRF table. However, a VPN site may have different user communities within the same enterprise. For example, an enterprise customer may have a site with thousands of employees and assuming all users benefit from the same VRF table may not be appropriate. As such, if the enterprise customer needs a different forwarding table to be used for a set of interfaces/users, then the network service provider has to create a new instance of the entire VRF for this set of interfaces. That means all the routes have to be duplicated for each unique forwarding instance. Duplication of all routes for each forwarding instance is very costly for the network service provider.

The present invention provides a method and apparatus for providing a hierarchical structure for routing on packet networks.

In order to clearly illustrate the teachings of the current invention, the following terminologies and networking concepts will first be described:

Virtual Private Network (VPN);

Customer Edge (CE);

Provider Edge (PE);

Border Gateway Protocol (BG P);

Label Distribution Protocol (LDP);

Forward Equivalent Class (FEC);

Label Switched Paths (LSP);

Label Edge Router (LER); and

Virtual Route Forwarding (VRF).

Virtual Private Network (VPN) is a private network that uses a public network to interconnect multiple sites and users. VPN uses virtual connections routed through the public network to connect remote sites, mobile users, corporate LANs, etc. For example, a VPN may have a LAN at a corporation's main office, remote LANs at branch offices and individual employees connecting to these LANs using endpoint devices such as PCs, laptops, mobile devices, etc. The public network may be the Internet or a network from a service provider.

Customer Edge refers to a device located at a customer location and is in communication with a provider edge device as defined below via a data link such as Ethernet, Frame Relay, etc. A customer edge device may be a router or a switch. A customer edge router is a routing peer to the provider edge device to which it is attached but not to other customer edge routers in other sites. In one embodiment, the customer edge device may provide the addresses at its site to the provider edge device using e.g., Border Gateway Protocol (BGP) as described below. The routing information about a particular VPN is present only in the PE routers attached to the VPN.

Provider Edge (PE) refers to a device, e.g., a router, administered by a network service provider and is used for communicating with customer edge devices. In one embodiment, a PE obtains routing information from the customer edge devices using e.g., Border Gateway Protocol. A PE may be used to attach labels to the customer traffic to identify the VPN associated with the packet. That is, the service provider provides VPN functionality to a set of customers using a PE device at the edge of the provider network.

Border Gateway Protocol (BGP) refers to a protocol designed to pass routing information between systems run by different administrators. BGP has methods for passing attributes of routes between a CE and a PE.

Label Distribution Protocol (LDP) is a protocol used to build label-switched router databases by exchanging label mapping information between two label switched routers.

Forward Equivalent Class (FEC) is a term that describes a set of packets that may be forwarded the same way based on characteristics or requirements. FEC may be defined based on quality of service, destination IP address, etc.

Label Switched Paths (LSPs) refer to pre-provisioned routes across an MPLS network using a signaling protocol such as Label Distribution Protocol (LDP) described above. LSPs are a sequence of labels inserted at the beginning of the packets at each device along the path from the source (or broadly a source node) to the destination (or broadly a destination node). The labels contain network protocol and information needed for forwarding packets. The LSPs are setup based on criteria in the Forward Equivalent Class (FEC) defined above.

Label Edge Router (LER) is a router located at the edge of an MPLS network that uses routing information to assign labels to data-grams and forward them into the MPLS domain. Hence, the path for a packet begins at an LER which assigns a label to it based on FEC criteria.

Virtual Route Forwarding (VRF) table refers to a routing information repository that defines the VPN membership of a customer site attached to the Provider Edge (PE) router. A VRF may contain a global IP routing table, rules for determining information to be contained in the routing table, a forwarding table, a list of interfaces that belong in the same VPN and are sharing the forwarding table, etc.

When a service provider provides a VPN service to a customer, the service provider instantiates a VRF for the customer. The VRF is instantiated for the VPN in the PE device. The PE device assigns labels for the routes in the VPN and distributes the routes e.g., as VPN-IPv4 addresses. For example, the assigned labels and the VPN identifier are encoded as part of network layer reach-ability information. The PE then exchanges the routes with its peers using VPN and IP addressing protocols, e.g., IPv4 and VPNv4.

When a PE router receives routes advertised by other routers, e.g., other PE routers and CE routers, the PE router gathers the routes and creates a VRF table that contains default (summary) routes as learned from one or more sources (peers). For example, if the PE router receives multiple route advertisements for the same destination, it selects a route and stores the selected route in the VRF table.

In one embodiment, the current invention provides a hierarchical structure for routing by enabling routing tables to be created for an interface or a group of interfaces. For example, a VPN site may have multiple CE routers attached to the same PE router. Interface specific routing tables may then be created in the PE to allow routing preference for users without creating a new instance of the entire VRF table. Note that routes in the VRF table are available as default. That means, if the PE router consults the interface specific routing table and is not successful in locating an interface specific route, the routes in the VRF table are available as default.

In one embodiment, the network service provider controls route preferences at an interface level from a centralized location, e.g., a centralized routing server. The centralized routing server may update the interface specific routing tables in PE routers based on network conditions, customer requests, and so on. For example, if network congestion is detected for a particular route, the network service provider may change interface specific routes and reduce the network congestion.

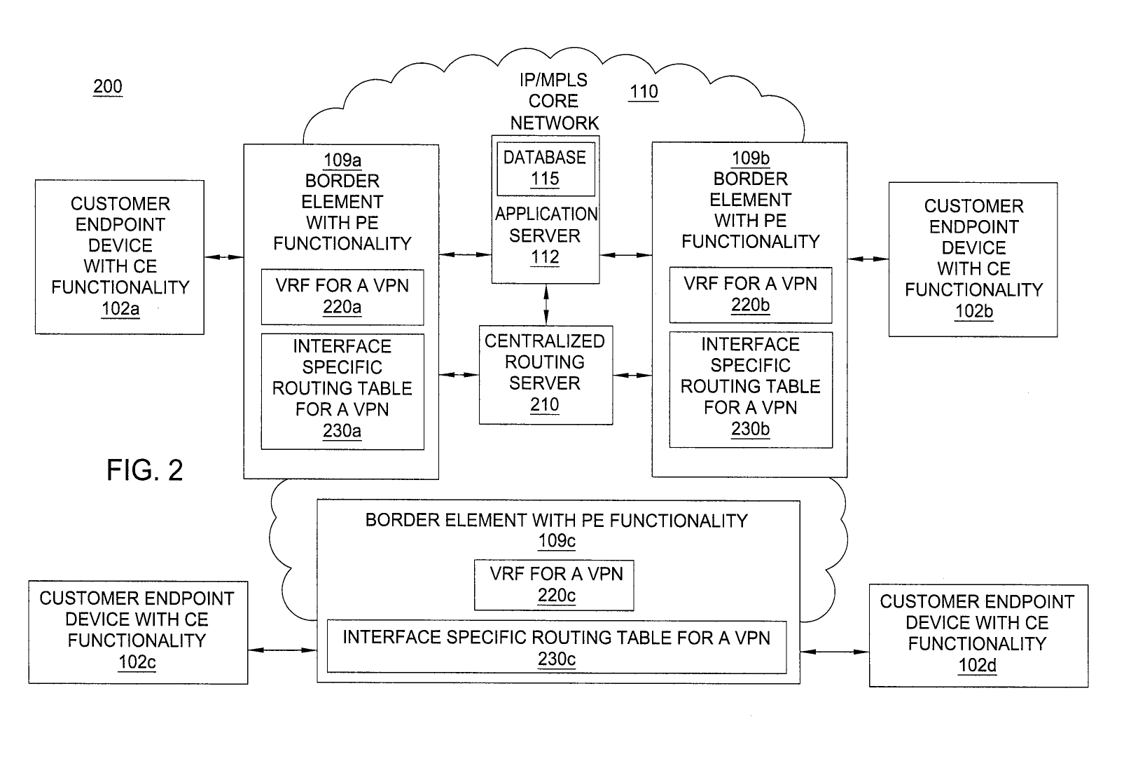

FIG. 2 illustrates an exemplary virtual private network 200 with one embodiment of the current invention for providing a hierarchical structure for routing. The customer endpoint devices with CE functionality 102a, 102b, 102c and 102d are located at various customer locations and are communicating with each other, e.g., over an IP/MPLS core network 110. The IP/MPLS core network 110 contains border elements 109a, 109b and 109c. The customer endpoint devices with CE functionality 102a, 102b, 102c and 102d are connected to a border element with PE functionality 109a, 109b or 109c. The border elements with PE functionality 109a, 109b and 109c contain VRF tables for the customer VPN 220a, 220b and 220c respectively. The border elements with PE functionality 109a, 109b and 109c also contain interface specific routing tables for the customer VPN 230a, 230b and 230c respectively.

The IP/MPLS core network 110 also contains an application server 112 for interacting with VPN customers and providing a hierarchical structure for routing. The application server 112 contains a database 115 for storing customer information and/or preference. The IP/MPLS core network 110 also contains a centralized routing server 210. In one embodiment, the centralized routing server 210 is used to advertise routes (update routes) from a centralized location. For example, routes may be advertised in response to a customer request, change in network conditions, and so on.

In FIG. 2, the customer may access application server 112 and request a VPN service with hierarchical structure for routing. A VPN is then established through the IP/MPLS network 110 for communication among the customer endpoint devices with CE functionality 102a-d. The customer may also provide interface specific route preference by accessing the application server 112. The application server 112 may record the customer preferences in the database 115. For example, the customer may prefer customer endpoint device 102c to use the route advertised by customer endpoint device 102a and customer endpoint device 102d to use the route advertised by customer endpoint device 102b. The centralized routing server 210 is in communication with application server 112 to access customer preferences for interface specific routing.

The customer endpoint device 102a advertises its VPN route via border element 109a. The customer endpoint device 102b advertises its VPN route via border element 109b. The customer endpoint devices 102c and 102d advertise their VPN routes via border element 109c. The border element 109a selects either the route it received from the border element 109b or the route it received from the border element 109c and populates the VRF table 220a. The border element 109b selects either the route it received from the border element 109a or the route it received from the border element 109c and populates the VRF table 220b. The border element 109c selects either the route it received from the border element 109a or the route it received from the border element 109b and populates the VRF table 220c.

In one embodiment, the border element 109c also populates the interface specific routing table 230c in accordance with the received interface specific routing preference. For example, for customer endpoint device 102c the route received via border element 109a is stored and for customer endpoint device 102d the route received via border element 109b is stored, pursuant to the customer's specific preference or other selection parameters. Similarly, the interface specific routing tables 230a and 230b are populated with the single entry for the customer endpoint device attached to them.

In operation, when a border element with PE functionality receives a packet from a customer endpoint device with CE functionality, the border element will first determine whether or not there is an interface specific routing table for the VPN. If an interface specific routing table is available for the VPN, then the border element will first consult the interface specific routing table. If a route for a destination is successfully located in the interface specific routing table, then the packet is forwarded using said route. However, if a route for the destination does not exist in the interface specific routing table, then the border element consults the VRF table. It should be noted that since the VRF table contains all available routes, a route will always be found.

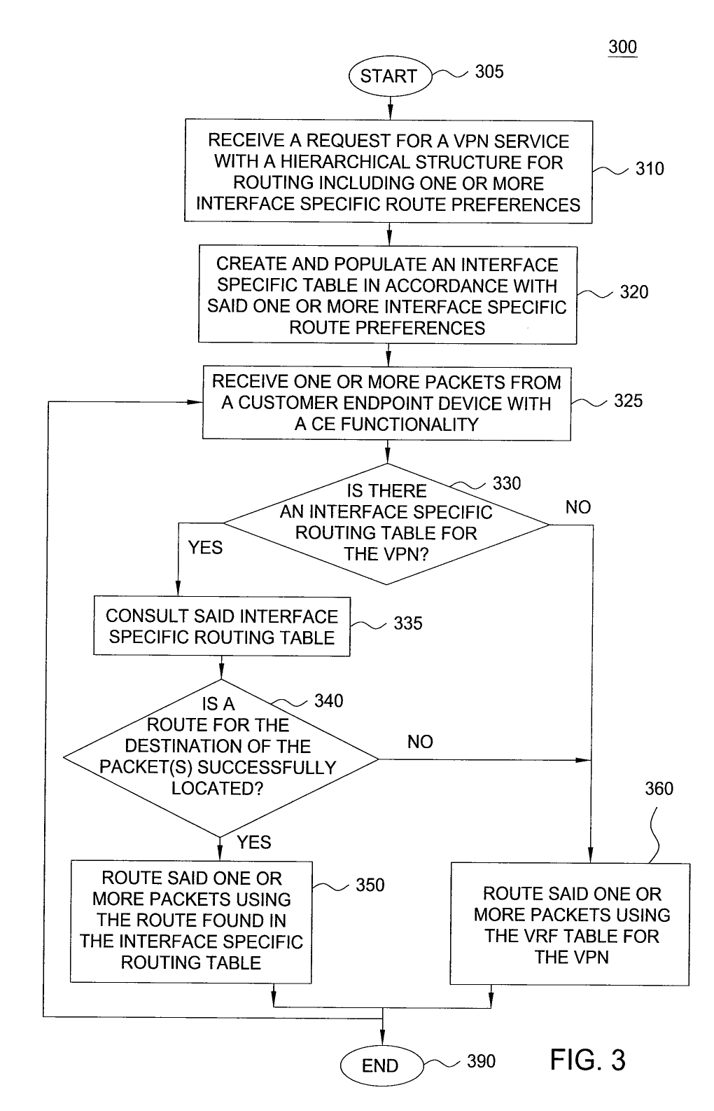

FIG. 3 illustrates a flowchart of one embodiment of the current method 300 for providing a hierarchical structure for routing. Method 300 starts in step 305 and proceeds to step 310.

In step 310, method 300 receives a request for a VPN service with a hierarchical structure for routing including one or more interface specific route preferences. For example, a customer may access an application server and submit a request for a VPN service with the interface specific routing preference service feature. Namely, the present invention can be provided as an optional service feature to a customer who wants the flexibility of having the interface specific routing feature.

In step 320, method 300 creates and populates an interface specific routing table in accordance with said interface specific route preferences. For example, a border element with PE functionality populates an interface specific routing table for a VPN from route preferences received in step 310 and/or routes learned from various peer routers.

In step 325, method 300 receives one or more packets from a customer endpoint device with a CE functionality. For example, a border element with PE functionality receives one or more packet(s) from a customer of a VPN service for forwarding towards another location on the same VPN.

In step 330, method 300 determines whether or not there is an interface specific routing table for the VPN. If there is an interface specific routing table for the VPN, then the method proceeds to step 335. Otherwise, the method proceeds to step 360, to route the packet using the VRF table.

In step 335, method 300 consults said interface specific routing table. The method then proceeds to step 340.

In step 340, method 300 determines whether or not a route for the destination of the packet(s) is successfully located. If a route is located, the method proceeds to step 350. Otherwise, the method proceeds to step 360.

In step 350, method 300 routes the one or more packets using the route found in the interface specific routing table. The method then proceeds to step 390 to end processing the current packet(s) or to step 325 to continue receiving packets.

In step 360, method 300 routes the one or more packets using the VRF table for the VPN. For example, the method may not have found any route for the destination in the interface specific routing table. The method then proceeds to step 390, to end processing the current packet(s) or to step 325 to continue receiving packets.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

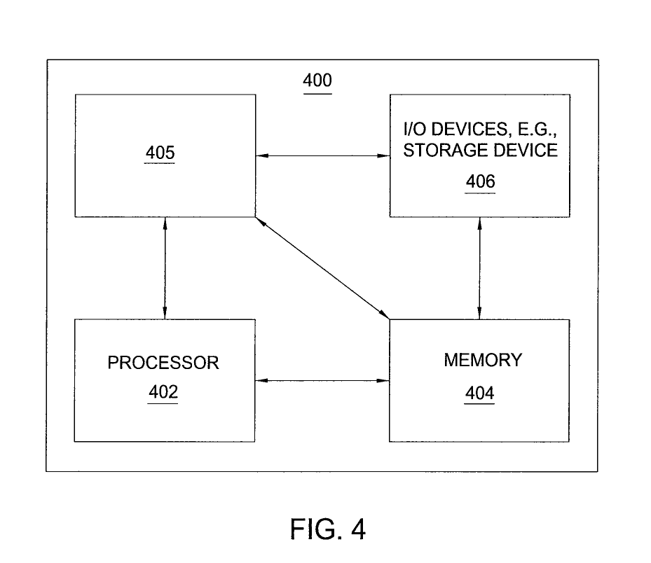

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing a hierarchical structure for routing over packet networks, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing a hierarchical structure for routing over packet networks can be loaded into memory 404 and executed by processor 402 to implement the functions as discussed above. As such, the present method 405 for providing a hierarchical structure for routing over packet networks (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a hierarchical structure for routing over packet networks, comprising:
receiving one or more packets from at least one customer endpoint device with a Customer Edge (CE) functionality, wherein said one or more packets are destined for a destination node;
locating a route for routing said one or more packets by consulting an interface specific routing table; and
forwarding said one or more packets towards said destination node using said route.

2. The method of claim 1, wherein said interface specific routing table is populated with at least one interface specific route preference.

3. The method of claim 2, wherein said at least one interface specific route preference is provided by a customer.

4. The method of claim 2, wherein said at least one interface specific route preference is provided by a network service provider.

5. The method of claim 4, wherein said at least one interface specific route preference provided by said network service provider is dynamically updated.

6. The method of claim 1, further comprising:
locating a route for routing said one or more packets by consulting a virtual route forwarding table if a route is not found in said interface specific routing table; and
forwarding said one or more packets towards said destination node using said route found in said virtual route forwarding table.

7. The method of claim 1, wherein said destination node is part of a virtual private network (VPN).

8. A computer-readable medium having stored thereon a plurality of instructions, the plurality of instructions including instructions which, when executed by a processor, cause the processor to perform the steps of a method for providing a hierarchical structure for routing over packet networks, comprising:
receiving one or more packets from at least one customer endpoint device with a Customer Edge (CE) functionality, wherein said one or more packets are destined for a destination node;
locating a route for routing said one or more packets by consulting an interface specific routing table; and
forwarding said one or more packets towards said destination node using said route.

9. The computer-readable medium of claim 8, wherein said interface specific routing table is populated with at least one interface specific route preference.

10. The computer-readable medium of claim 9, wherein said at least one interface specific route preference is provided by a customer.

11. The computer-readable medium of claim 9, wherein said at least one interface specific route preference is provided by a network service provider.

12. The computer-readable medium of claim 11, wherein said at least one interface specific route preference provided by said network service provider is dynamically updated.

13. The computer-readable medium of claim 8, further comprising:
locating a route for routing said one or more packets by consulting a virtual route forwarding table if a route is not found in said interface specific routing table; and
forwarding said one or more packets towards said destination node using said route found in said virtual route forwarding table.

14. The computer-readable medium of claim 8, wherein said destination node is part of a virtual private network (VPN).

15. An apparatus for providing a hierarchical structure for routing over packet networks, comprising:
means for receiving one or more packets from at least one customer endpoint device with a Customer Edge (CE) functionality, wherein said one or more packets are destined for a destination node;
means for locating a route for routing said one or more packets by consulting an interface specific routing table; and
means for forwarding said one or more packets towards said destination node using said route.

16. The apparatus of claim 15, wherein said interface specific routing table is populated with at least one interface specific route preference.

17. The apparatus of claim 16, wherein said at least one interface specific route preference is provided by a customer.

18. The apparatus of claim 16, wherein said at least one interface specific route preference is provided by a network service provider.

19. The apparatus of claim 18, wherein said at least one interface specific route preference provided by said network service provider is dynamically updated.

20. The apparatus of claim 15, further comprising:
means for locating a route for routing said one or more packets by consulting a virtual route forwarding table if a route is not found in said interface specific routing table; and
means for forwarding said one or more packets towards said destination node using said route found in said virtual route forwarding table.
